(19) United States
(12) Patent Application Publication
(10) Pub. No.: US 2024/0154633 A1
(43) Pub. Date: May 9, 2024

(54) MULTIPLE CONCURRENT ANTENNA CONFIGURATIONS FOR ENHANCED TRANSMITTER POWER CAPABILITY

(71) Applicant: SKYWORKS SOLUTIONS, INC., Irvine, CA (US)

(72) Inventor: David Richard Pehlke, Westlake Village, CA (US)

(21) Appl. No.: 18/387,513

(22) Filed: Nov. 7, 2023

Related U.S. Application Data
(60) Provisional application No. 63/423,840, filed on Nov. 9, 2022.

(51) Int. Cl. H04B 1/00

(52) U.S. Cl. CPC H04B 1/0078; H04B 1/006; H04B 2001/0408

(57) ABSTRACT

A radio frequency module including a power amplifier configured to amplify a transmit radio frequency signal and including an output having a first output impedance; and an antenna switch module. The antenna switch module is coupled to the output of the power amplifier and configured to connect at least a first antenna having a first input impedance in parallel with at least a second antenna having a second input impedance to the output of the power amplifier so that a parallel connection of the first and second input impedance matches the first output impedance.

### CROSS-REFERENCE TO RELATED APPLICATIONS

This application claims priority under 35 U.S.C. § 119(e) to U.S. Provisional Patent Application Ser. No. 63/423,840, titled “MULTIPLE CONCURRENT ANTENNA CONFIGURATIONS FOR ENHANCED TRANSMITTER POWER CAPABILITY,” filed Nov. 9, 2022, the entire contents of which is incorporated herein by reference for all purposes.

### BACKGROUND

### Field

Embodiments of the present disclosure relate to radio frequency (RF) modules and/or wireless communication devices.

### Description of the Related Technology

Aspects of this disclosure relate to cellular communication systems, and in particular, to systems for high power uplink transmission for frequency division duplex (FDD) communication systems. The Specific Absorption Rate (SAR) is a measure of the energy absorbed per unit mass by a human body when exposed to a RF electromagnetic field. It can be defined as the power absorbed per mass of tissue in watts per kilogram (W/kg). Cellular user equipment (UE) must measure below Specific Absorption Rate (SAR) regulatory limits, and therefore transmit below a maximum average power in the uplink (UL) between the UE and a base station. For instance, FDD systems which transmit and receive continuously, transmit with a maximum average power below a threshold such that the total radiated power (TRP) complies with relevant SAR limits.

Established cellular communication networks are typically limited in coverage extent by two factors: capacity and the need to provide a target level of data rate and service to a large number of people in a dense area, and/or coverage range which is typically limited by UL power from battery powered mobile handsets or wearable devices.

The capacity issue can be addressed in certain environments via the establishment of smaller cells and densification of the network. Coexistence interference issues can become more prevalent in such radio environments, and thus higher uplink power may not necessarily be favored depending on how the uplink power is scheduled to overcome coexistence challenges.

The UL-limited coverage issue is largely the result of an asymmetry in the power between the transmitter of the base station and the mobile handset. Downlink (DL) power from the base station is typically in the range of 40 W from high performance antennas and typically less than ¼ W from the mobile device. The receivers for both the base station and mobile handset are much closer to one another, both close to the theoretical physical noise limits.

Operation at the cell edge (e.g., when the user is substantially equally distant from multiple base stations) requires the highest power levels and typically reduces the modulation allocation and backs off the order of modulation to narrower bandwidths and simple Quadrature Phase-Shift Keying (QPSK) in order to preserve the signal-to-noise ratio of the UL modulation, LTE being made up of individual resource blocks (RBs). The DL can operate without changes in allocation as the transmission of the entire channel and multiple channels for the DL is typically operated at maximum power from the base station. The UL must work hard and make these trade-offs to preserve UL SNR and maintain the link back to the eNodeB (LTE) or gNodeB (NR).

Additionally, because cellphones are presently used approximately 75% of the time indoors where building penetration (especially at higher frequencies) becomes a significant challenge, cellphones may be effectively operating at the cell edge (e.g., where the link SNR degrades to a point where the link and service is at risk of being dropped, similar to the risks associated at the cell edge).

The call drop statistics and buffering indicated during low data rate periods are perhaps one of the most critical user experience statistics driving customer churn and dissatisfaction and drive much of the consumer perception of the carrier services. In continuous transmission of Frequency-Division Duplex (FDD), UL power is limited by regulatory safety limits of average power-termed Specific Absorbed Radiation (SAR) as indicators of safe amounts of electromagnetic energy absorbed in human tissue. It is not possible to increase the maximum FDD UL power because of this limit, and the Total Radiated Power (TRP) is made as high as possible to meet carrier requirements, while still meeting the regulatory maximum average power based on SAR.

Aspects of this disclosure relate to systems and methods which can provide improved UL power transmission for FDD communication without exceeding the SAR regulatory limit.

### SUMMARY

According to an aspect of the present disclosure, a radio frequency module is provided. The radio frequency module comprises a power amplifier configured to amplify a transmit radio frequency signal and including an output having a first output impedance; and an antenna switch module. The antenna switch module is coupled to the output of the power amplifier and configured to connect at least a first antenna having a first input impedance in parallel with at least a second antenna having a second input impedance to the output of the power amplifier so that the parallel connection of the first and second input impedance matches the first output impedance.

In accordance with one example, the power amplifier is configured to adaptively adjust its power capability when the impedance of a load on the radio frequency module changes, in particular becomes lower.

In accordance with another example, the radio frequency module further comprises a radio frequency filter implemented between the power amplifier and the first antenna. In accordance with an example, the radio frequency filter is configured as a bandpass output filter. In accordance with another aspect, the performance of the radio frequency filter is invariant with respect to a changing impedance at the output of the radio frequency filter. In accordance with a further example, the radio frequency module further comprises a tunable matching network coupled between the radio frequency filter and the antenna switch module, the tunable matching network configured to adjust the output impedance of the radio frequency filter in a predefined range. According to another example, the antenna switch module is implemented between the power amplifier and the radio frequency filter, the radio frequency filter being configured as a duplex filter.

In accordance with another example, the radio frequency module further comprises a phase shifting circuit configured to phase shift the transmit radio frequency signal when the at least one second antenna is concurrently connected in parallel with the at least one first antenna. In accordance with one example, the phase shifting circuit is implemented in the antenna switch module and configured as an adjustable phase shifting network. In another example, the phase shifting circuit is implemented between the antenna switch module and each of the at least one first and the at least one second antenna, the phase shifting circuit being configured as a low-loss phase shifting network.

In accordance with a further example, the antenna switch module is configured as a multi-pole multi-throw (MPMT) switch, in particular as a double-pole double-throw (DP2T) switch.

In another example, the radio frequency module further comprises a low noise amplifier coupled to the antenna switch module and configured to receive a receive radio frequency signal.

In another example, the radio frequency module is configured as a front end module.

In accordance with another aspect of the present invention, a wireless communication device is provided. The wireless communication device comprises at least one first antenna configured to transmit a first transmit radio frequency signal to a base station via a first uplink and to receive a first receive radio frequency signal from the base station via a first downlink, at least one second antenna configured to transmit a second transmit radio frequency signal to a base station via a second uplink and to receive a second receive radio frequency signal from the base station via a second downlink, and a radio frequency module coupled to the at least one first antenna and the at least one second antenna. The radio frequency module includes a power amplifier configured to amplify the first and second transmit radio frequency signal and including an output having a first output impedance, and an antenna switch module. The antenna switch module is coupled to the output of the power amplifier and configured to connect at least the first antenna having a first input impedance in parallel with the at least a second antenna having a second input impedance to the output of the power amplifier so that the parallel connection of the first and second input impedance matches the first output impedance.

In accordance with one example, the power amplifier is configured to adaptively adjust its power capability when the impedance of a load on the radio frequency module changes, in particular becomes lower.

In accordance with another example, the radio frequency module includes a radio frequency filter implemented between the power amplifier and the first antenna. In one example, the radio frequency filter is configured as a bandpass output filter. In another example, the performance of the radio frequency filter is invariant with respect to a changing impedance at the output of the radio frequency filter. In yet another example, the radio frequency module further includes a tunable matching network coupled between the radio frequency filter and the antenna switch module, the tunable matching network configured to adjust the output impedance of the radio frequency filter in a predefined range. In a further example, the antenna switch module is implemented between the power amplifier and the radio frequency filter, the radio frequency filter being configured as a duplex filter.

In accordance with an example, the radio frequency module further includes a phase shifting circuit configured to phase shift the transmit radio frequency signal when the at least one second antenna is concurrently connected in parallel with the at least one first antenna. In one example, the phase shifting circuit is implemented in the antenna switch module and configured as an adjustable phase shifting network. In another example, the phase shifting circuit is implemented between the antenna switch module and each of the at least one first antenna and the at least one second antenna, the phase shifting circuit being configured as a low-loss phase shifting network.

In accordance with another example, the antenna switch module is configured as a multi-pole multi-throw (MPMT) switch, in particular as a double-pole double-throw (DP2T) switch.

In yet a further example, the radio frequency module further includes a low noise amplifier coupled to the antenna switch module and configured to receive the receive radio frequency signal received from the base station.

In one example, the radio frequency module is configured as a front end module.

In another example, the wireless communication device further comprises a transceiver coupled to the radio frequency module and configured to generate the transmit radio frequency signal and to process the receive radio frequency signal.

### BRIEF DESCRIPTION OF THE DRAWINGS

FIG. 1 is a schematic diagram of one example of a communication network.

FIG. 2 is a schematic diagram of one example of a communication link using carrier aggregation.

FIG. 3A is a schematic diagram of one example of a downlink channel using multi-input and multi-output (MIMO) communications.

FIG. 3B is schematic diagram of one example of an uplink channel using MIMO communications.

FIG. 3C is schematic diagram of another example of an uplink channel using MIMO communications.

FIG. 4 is a schematic diagram of one example of a radio frequency module.

FIG. 5 is a schematic diagram of a second example of a radio frequency module.

FIG. 6 is a schematic diagram of a third example of a radio frequency module.

FIG. 7 is a schematic diagram of a fourth example of a radio frequency module.

FIG. 8 is a schematic block diagram of one example of a wireless device.

FIG. 9 is a schematic block diagram of one example of a mobile device.

### DETAILED DESCRIPTION OF EMBODIMENTS

The following detailed description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

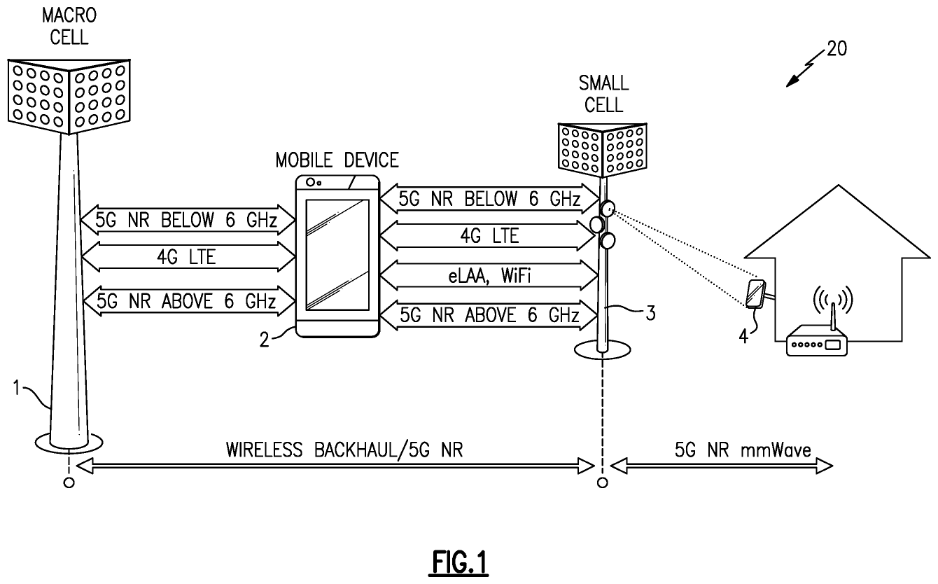

FIG. 1 is a schematic diagram of one example of a communication network 20. The communication network 20 includes a macro cell base station 1, a mobile device 2, a small cell base station 3, and a stationary wireless device 4.

The illustrated communication network 20 of FIG. 1 supports communications using a variety of technologies, including, for example, 4G LTE, 5G NR, and wireless local area network (WLAN), such as Wi-Fi. In the communication network 20, dual connectivity can be implemented with concurrent 4G LTE and 5G NR communication with the mobile device 2. Although various examples of supported communication technologies are shown, the communication network 20 can be adapted to support a wide variety of communication technologies.

Various communication links of the communication network 20 have been depicted in FIG. 1. The communication links can be duplexed in a wide variety of ways, including, for example, using frequency-division duplexing (FDD) and/or time-division duplexing (TDD). FDD is a type of radio frequency communications that uses different frequencies for transmitting and receiving signals. FDD can provide a number of advantages, such as high data rates and low latency. In contrast, TDD is a type of radio frequency communications that uses about the same frequency for transmitting and receiving signals, and in which transmit and receive communications are switched in time. TDD can provide a number of advantages, such as efficient use of spectrum and variable allocation of throughput between transmit and receive directions.

As shown in FIG. 1, the mobile device 2 communicates with the macro cell base station 1 over a communication link that uses a combination of 4G LTE and 5G NR technologies. The mobile device 2 also communications with the small cell base station 3. In the illustrated example, the mobile device 2 and small cell base station 3 communicate over a communication link that uses 5G NR, 4G LTE, and Wi-Fi technologies. In certain implementations, enhanced license assisted access (eLAA) is used to aggregate one or more licensed frequency carriers (for instance, licensed 4G LTE and/or 5G NR frequencies), with one or more unlicensed carriers (for instance, unlicensed Wi-Fi frequencies).

In certain implementations, the mobile device 2 communicates with the macro cell base station 2 and the small cell base station 3 using 5G NR technology over one or more frequency bands that are less than 7.5 Gigahertz (GHz) and/or over one or more frequency bands that are greater than 7.5 GHz. For example, wireless communications can utilize Frequency Range 1 (FR1), Frequency Range 2 (FR2), or a combination thereof. In one embodiment, the mobile device 2 supports a HPUE power class specification.

The illustrated small cell base station 3 also communicates with a stationary wireless device 4. The small cell base station 3 can be used, for example, to provide broadband service using 5G NR technology. In certain implementations, the small cell base station 3 communicates with the stationary wireless device 4 over one or more millimeter wave frequency bands in the frequency range of 30 GHz to 300 GHz and/or upper centimeter wave frequency bands in the frequency range of 24 GHz to 30 GHz.

In certain implementations, the small cell base station 3 communicates with the stationary wireless device 4 using beamforming. For example, beamforming can be used to focus signal strength to overcome path losses, such as high loss associated with communicating over millimeter wave frequencies.

The communication network 20 of FIG. 1 includes the macro cell base station 1 and the small cell base station 3. In certain implementations, the small cell base station 3 can operate with relatively lower power, shorter range, and/or with fewer concurrent users relative to the macro cell base station 1. The small cell base station 3 can also be referred to as a femtocell, a picocell, or a microcell.

Although the communication network 20 is illustrated as including two base stations, the communication network 20 can be implemented to include more or fewer base stations and/or base stations of other types. As shown in FIG. 1, base stations can communicate with one another using wireless communications to provide a wireless backhaul. Additionally or alternatively, base stations can communicate with one another using wired and/or optical links.

The communication network 20 of FIG. 1 is illustrated as including one mobile device and one stationary wireless device. The mobile device 2 and the stationary wireless device 4 illustrate two examples of user devices or user equipment (UE). Although the communication network 20 is illustrated as including two user devices, the communication network 20 can be used to communicate with more or fewer user devices and/or user devices of other types. For example, user devices can include mobile phones, tablets, laptops, Internet of Things (IoT) devices, wearable electronics, and/or a wide variety of other communications devices.

User devices of the communication network 20 can share available network resources (for instance, available frequency spectrum) in a wide variety of ways.

In one example, frequency division multiple access (FDMA) is used to divide a frequency band into multiple frequency carriers. Additionally, one or more carriers are allocated to a particular user. Examples of FDMA include, but are not limited to, single carrier FDMA (SC-FDMA) and orthogonal FDMA (OFDMA). OFDMA is a multicarrier technology that subdivides the available bandwidth into multiple mutually orthogonal narrowband subcarriers, which can be separately assigned to different users.

Other examples of shared access include, but are not limited to, time division multiple access (TDMA) in which a user is allocated particular time slots for using a frequency resource, code division multiple access (CDMA) in which a frequency resource is shared amongst different users by assigning each user device a unique code, space-divisional multiple access (SDMA) in which beamforming is used to provide shared access by spatial division, and non-orthogonal multiple access (NOMA) in which the power domain is used for multiple access. For example, NOMA can be used to serve multiple user devices at the same frequency, time, and/or code, but with different power levels.

Enhanced mobile broadband (eMBB) refers to technology for growing system capacity of LTE networks. For example, eMBB can refer to communications with a peak data rate of at least 10 Gbps and a minimum of 100 Mbps for each user device. Ultra-reliable low latency communications (uRLLC) refers to technology for communication with very low latency, for instance, less than 2 milliseconds. uRLLC can be used for mission-critical communications such as for autonomous driving and/or remote surgery applications. Massive machine-type communications (mMTC) refers to low cost and low data rate communications associated with wireless connections to everyday objects, such as those associated with IoT applications.

The communication network 20 of FIG. 1 can be used to support a wide variety of advanced communication features, including, but not limited to eMBB, uRLLC, and/or mMTC.

A peak data rate of a communication link (for instance, between a base station and a user device) depends on a variety of factors. For example, peak data rate can be affected by the channel bandwidth, the modulation order, the number of component carriers, and/or the number of antennas used for communications.

For instance, in certain implementations, the data rate of a communication link can be about equal to M*B*log₂(1+S/N), where M is the number of communication channels, B is the channel bandwidth, and S/N is the signal-to-noise ratio (SNR).

Accordingly, the data rate of a communication link can be increased by increasing the number of communication channels (for instance, transmitting and receiving using multiple antennas), using wider bandwidth (for instance, by aggregating carriers), and/or improving SNR (for instance, by increasing transmit power and/or improving receiver sensitivity).

5G NR communication systems can employ a wide variety of techniques for enhancing data rate and/or communication performance.

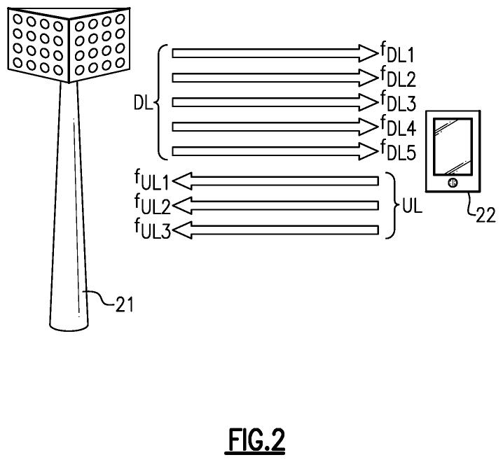

FIG. 2 is a schematic diagram of one example of a communication link using carrier aggregation. Carrier aggregation can be used to widen bandwidth of the communication link by supporting communications over multiple frequency carriers, thereby increasing user data rates and enhancing network capacity by utilizing fragmented spectrum allocations. Carrier aggregation can present technical challenges for measuring power of individual carriers. Radio frequency systems disclosed herein can measure power associated with one or more transmit paths in carrier aggregation applications. Embodiments disclosed herein can be implemented in carrier aggregation applications.

In the illustrated example, the communication link is provided between a base station 21 and a mobile device 22. As shown in FIG. 2, the communications link includes a downlink channel used for RF communications from the base station 21 to the mobile device 22, and an uplink channel used for RF communications from the mobile device 22 to the base station 21.

Although FIG. 2 illustrates carrier aggregation in the context of FDD communications, carrier aggregation can also be used for TDD communications.

In certain implementations, a communication link can provide asymmetrical data rates for a downlink channel and an uplink channel. For example, a communication link can be used to support a relatively high downlink data rate to enable high speed streaming of multimedia content to a mobile device, while providing a relatively slower data rate for uploading data from the mobile device to the cloud.

In the illustrated example, the base station 21 and the mobile device 22 communicate via carrier aggregation, which can be used to selectively increase bandwidth of the communication link. Carrier aggregation includes contiguous aggregation, in which contiguous carriers within the same operating frequency band are aggregated. Carrier aggregation can also be non-contiguous, and can include carriers separated in frequency within a common band or in different bands.

In the example shown in FIG. 2, the uplink channel includes three aggregated component carriers fUL1, fUL2, and fUL3. Additionally, the downlink channel includes five aggregated component carriers fDL1, fDL2, fDL3, fDL4, and fDL5. Although one example of component carrier aggregation is shown, more or fewer carriers can be aggregated for uplink and/or downlink. Moreover, a number of aggregated carriers can be varied over time to achieve desired uplink and downlink data rates.

For example, a number of aggregated carriers for uplink and/or downlink communications with respect to a particular mobile device can change over time. For example, the number of aggregated carriers can change as the device moves through the communication network and/or as network usage changes over time.

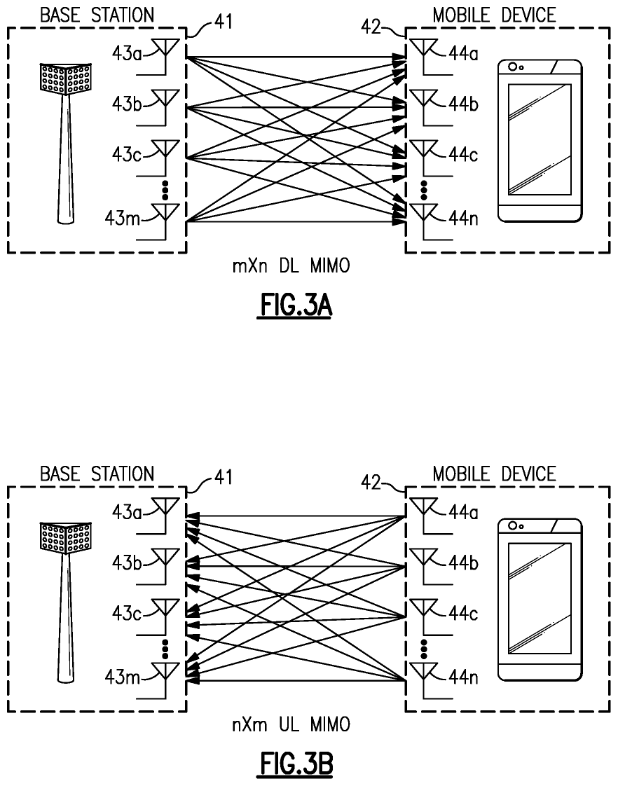

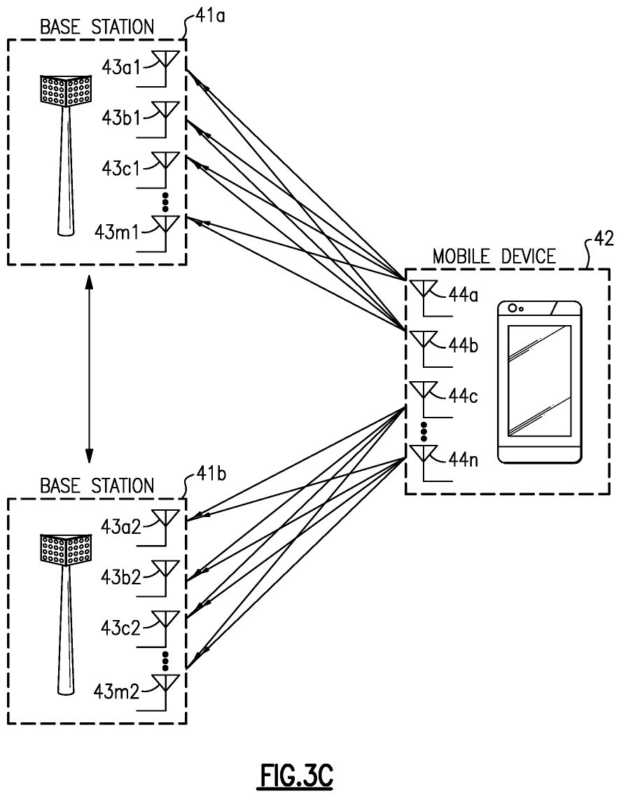

FIG. 3A is a schematic diagram of one example of a downlink channel using multi-input and multi-output (MIMO) communications. FIG. 3B is schematic diagram of one example of an uplink channel using MIMO communications.

MIMO communications use multiple antennas for simultaneously communicating multiple data streams over a common frequency spectrum. In certain implementations, the data streams operate with different reference signals to enhance data reception at the receiver. MIMO communications benefit from higher SNR, improved coding, and/or reduced signal interference due to spatial multiplexing differences of the radio environment.

MIMO order refers to a number of separate data streams sent or received. For instance, MIMO order for downlink communications can be described by a number of transmit antennas of a base station and a number of receive antennas for UE, such as a mobile device. For example, two-by-two (2×2) DL MIMO refers to MIMO downlink communications using two base station antennas and two UE antennas. Additionally, four-by-four (4×4) DL MIMO refers to MIMO downlink communications using four base station antennas and four UE antennas.

In the example shown in FIG. 3A, downlink MIMO communications are provided by transmitting using M antennas 43a, 43b, 43c, . . . 43m of the base station 41 and receiving using N antennas 44a, 44b, 44c, . . . 44n of the mobile device 42. Accordingly, FIG. 3A illustrates an example of m×n DL MIMO.

Likewise, MIMO order for uplink communications can be described by a number of transmit antennas of UE, such as a mobile device, and a number of receive antennas of a base station. For example, 2×2 UL MIMO refers to MIMO uplink communications using two UE antennas and two base station antennas. Additionally, 4×4 UL MIMO refers to MIMO uplink communications using four UE antennas and four base station antennas.

In the example shown in FIG. 3B, uplink MIMO communications are provided by transmitting using N antennas 44a, 44b, 44c, . . . 44n of the mobile device 42 and receiving using M antennas 43a, 43b, 43c, . . . 43m of the base station 41. Accordingly, FIG. 3B illustrates an example of n×m UL MIMO.

By increasing the level or order of MIMO, bandwidth of an uplink channel and/or a downlink channel can be increased.

MIMO communications are applicable to communication links of a variety of types, such as FDD communication links and TDD communication links.

FIG. 3C is schematic diagram of another example of an uplink channel using MIMO communications. In the example shown in FIG. 3C, uplink MIMO communications are provided by transmitting using N antennas 44a, 44b, 44c, . . . 44n of the mobile device 42. Additionally, a first portion of the uplink transmissions are received using M antennas 43a1, 43b1, 43c1, . . . 43m1 of a first base station 41a, while a second portion of the uplink transmissions are received using M antennas 43a2, 43b2, 43c2, . . . 43m2 of a second base station 41b. Additionally, the first base station 41a and the second base station 41b communicate with one another over wired, optical, and/or wireless links.

The MIMO scenario of FIG. 3C illustrates an example in which multiple base stations cooperate to facilitate MIMO communications.

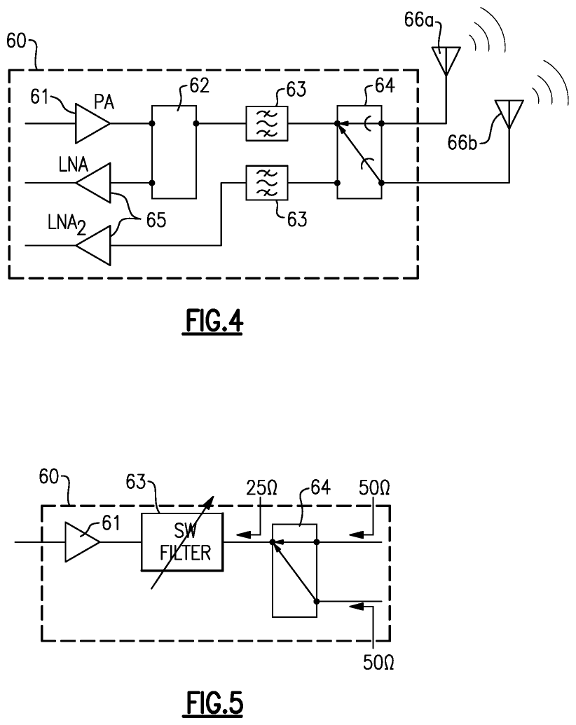

FIG. 4 is a schematic diagram of an example of a radio frequency module 60. In the illustrated example, the radio frequency module 60 comprises a power amplifier 61, a switch 62, a radio frequency filter 63, an antenna switch module 64 and a low noise amplifier 65.

The radio frequency module 60 transmits a transmit radio frequency signal to at least one first antenna 66a and receives a receive radio frequency signal from the at least one first antenna 66a and routes the receive radio frequency signal through the appropriate radio frequency filter 63 to the low noise amplifier 65 for subsequent downconversion and baseband processing. The first antenna 66a has a first input impedance. The low noise amplifier 65 may be coupled to the antenna switch module 64 and configured to receive the receive radio frequency signal. The receive radio frequency signal may be received as an FDD signal or a TDD signal, and have a specific frequency band configuration.

The power amplifier 61 is configured to amplify the transmit radio frequency signal. Furthermore, the power amplifier 61 includes an output having a first output impedance. The power amplifier 61 may receive the transmit radio frequency signal from a transceiver at an input of the power amplifier 61. Optionally, the power amplifier 61 is configured to adaptively adjust its power capability when the impedance of a load on the radio frequency module 60 changes. In particular, the power amplifier 61 is configured to adaptively adjust its power capability when the impedance of a load on the radio frequency module 60 becomes lower.

The switch 62 is configured to route the transmit radio frequency signal from the output of the power amplifier 61 to the radio frequency filter 63 and to route the receive radio frequency signal from the radio frequency filter 63 to the low noise amplifier 65, for example.

The radio frequency filter 63 is implemented between the power amplifier 61 and the first antenna 66a. Preferably, the radio frequency filter 63 is implemented between the switch 62 and the antenna switch module 64, as it is illustrated in FIG. 4. In particular, the radio frequency filter 63 is configured as a duplexer filter configured to filter transmit and receive FDD RF signals in radio devices, where the transmission and the reception are made at different frequencies via the first antenna 66a and the second antenna 66b.

Typically, a duplexer filter is a three-port circuit element comprising transmitter port, a receiver port, and an antenna port. An RF signal supplied to the transmitter port at the transmit frequency sees the signal path towards the receiver port as a high impedance, so that the radio power is not substantially directed to the receiver port, but it is directed through the antenna port to the antenna, where it is radiated as a RF signal to the environment. Correspondingly, an RF signal received through the antenna and the antenna port at the receive frequency sees the transmitter port as a high impedance, so that it is directed to the receiver port and further to the receiver sections of the radio device. The function of the duplexer filter is generally based on different frequency response characteristics of the filter components. The duplexer filter 63 can comprise a transmit filter and a receive filter. The duplex filter 63 can further comprise or be configured as a bandpass output filter. Further combinations of these Tx and Rx bands can be logically extended to gang multiple Tx and Rx filters together toward a single antenna port as well.

The antenna switch module 64 is coupled to the output of the power amplifier 61. Furthermore, the antenna switch module 64 is configured to connect the first antenna 66a having the first input impedance in parallel with at least a second antenna 66b having a second input impedance to the output of the power amplifier 61 so that the parallel connection of the first and second input impedance matches the first output impedance of the power amplifier 61.

Further, the antenna switch module 64 can be configured to support transmitting RF signals. In the example illustrated in FIG. 4, the antenna switch module 64 routes the transmit radio frequency signal from the selected filter 63 to the first antenna 66a and to the second antenna 66b for transmission of the same transmit radio frequency signal. The antenna switch module 64 can be configured to select at least one filter among a plurality of filters. In the example illustrated in FIG. 4, the antenna switch module 64 is configured as a double-pole double-throw (DP2T) switch. One pole of the DP2T switch is electrically coupled to the power amplifier 61. The other pole of the DP2T switch is electrically coupled to the low noise amplifier 65. One throw of the DP2T switch is electrically coupled to the first antenna 66a. The other throw of the DP2T switch is electrically coupled to the second antenna 66b. However, the antenna switch module 64 is not limited to the DP2T switch, but can also be configured as a multi-pole multi-throw (MPMT) switch, with the quantity M being an integer greater than 1. The position of the antenna switch module 64 can be controlled by at least one signal from a baseband subsystem that includes a processor and/or is based at least in part on a frequency band configuration.

Hence, the proposed innovation provides an additional concurrent switching in of other, in particular at least one second antenna 66b, antenna connections such that the individual ˜50 Ohm impedances combine in parallel. Therefore, the combined impedance of the load by the number of concurrent antenna feeds switched in can be reduced, applying ˜50 Ohm/n, wherein n is the number of antenna concurrently switched in.

Optionally, the radio frequency module 60 can further comprise a phase shifting circuit configured to phase shift the transmit radio frequency signal when the second antenna 66b is concurrently connected in parallel with the first antenna 66a. Thereby, the phase shifting circuit may be implemented in the antenna switch module 64 and configured as an adjustable/tunable phase shifting network. Alternatively or additionally, the phase shifting circuit is implemented between the antenna switch module 64 and the first antenna 66a as well as the second antenna 66b. That means the phase shifting network can be implemented post the antenna switch module 64 on each separate path coupled to the antennas 66a, 66b. The phase shifting circuit can be configured as a low-loss phase shifting network, for instance.

Advantageously, the radio frequency module 60 can enable a connectivity change, a tunable adjustment as required, and the resulting lower impedance of concurrent transmitter paths to provide higher linear power capability from a single low cost power amplifier for more efficient and cost-effective power delivery for the critical cellular limitation in UL power. The transmission of the same power as existed for the single antenna can be transmitted from multiple antennas as long as there is not overlapping coherence between the antennas for factors like SAR, etc. which is certainly the case for MB/HB and higher frequencies where the SAR is more a localized issue.

Further, by switching in multiple antenna loads more power can be delivered to the at least one first antenna 66a and the at least one second antenna 66b for transmitting the Tx signal. The load impedance can be reduced and Psat and Prms,max can be increased.

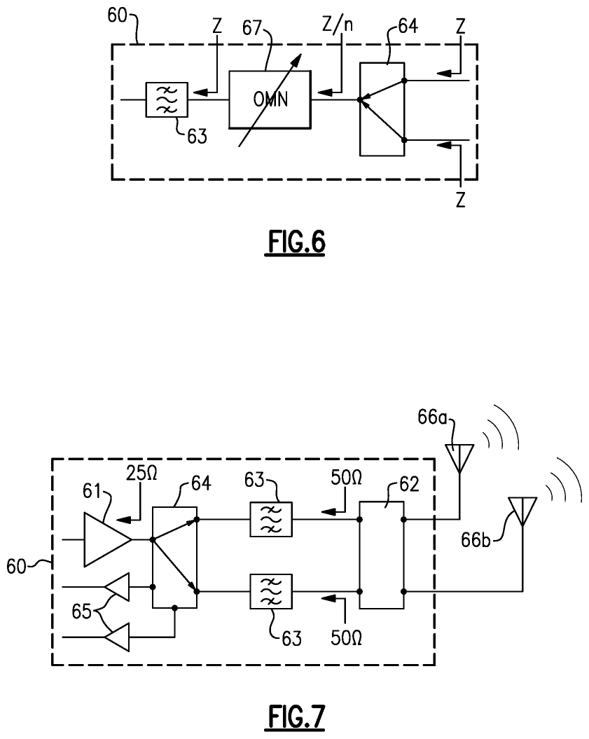

FIG. 5 is a schematic diagram of a second example of a radio frequency module 60. The radio frequency module 60 may substantially comprise the same features as in FIG. 4, wherein the radio frequency module 60 according to FIG. 5 differs in that the radio frequency module 60 comprises a radio frequency filter 63 implemented between the power amplifier 61 and the first antenna, wherein the performance of the radio frequency filter 63 is invariant with respect to a changing impedance at the output of the radio frequency filter 63.

Therefore, the radio frequency filter 63 is tolerant to the change in impedance presented and an impedance match adjustment between an output impedance of the radio frequency filter 63 and the antenna impedance can be omitted. Preferably, the radio frequency filter 63 is implemented between the power amplifier 61 and an antenna module 64 coupled to a first and a second antenna. Furthermore, the radio frequency filter 63 can be configured as a bandpass output filter.

FIG. 6 is a schematic diagram of a third example of a radio frequency module 60. This example differs from that in FIG. 5 in that the radio frequency module 60 comprises a tunable matching network 67 coupled between the radio frequency filter 63 and the antenna switch module 64. The tunable matching network 67 is configured to adjust the output impedance of the radio frequency filter 63 in a predefined range. Thus, the new impedance can be adjusted to a more suitable range of loading impedance. For instance, the tunable matching network 67 can be configured as an output matching network (OMN).

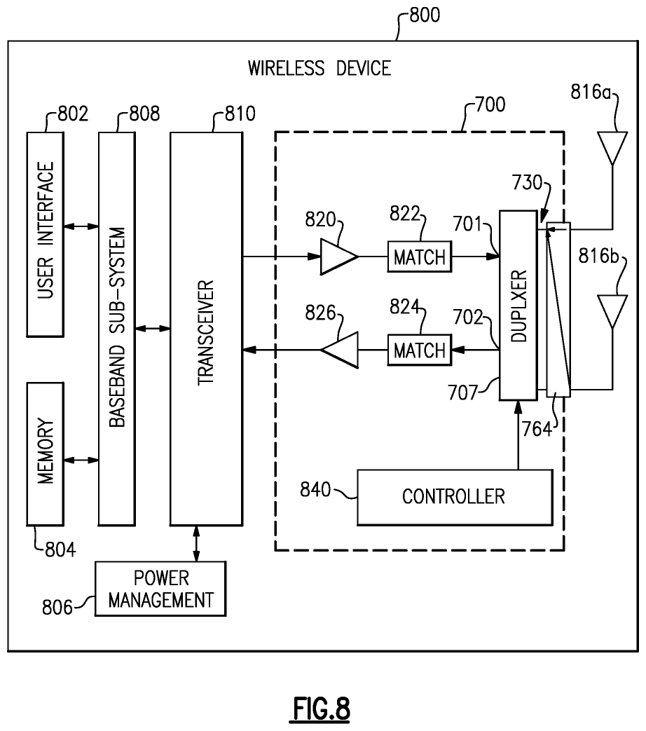

FIG. 7 is a schematic diagram of a fourth example of a radio frequency module 60. This example differs from that in FIG. 4 in that the antenna switch module 64 is implemented between the power amplifier 61 and the radio frequency filter 63. Thereby, the radio frequency filter 63 is configured as a duplex filter. Hence, re-use of existing bandpass output filter in TDD for Rx can be re-purposed for dual Tx/Rx use as it is illustrated in FIG. 7. Further, the concurrent connectivity can be adjusted at the power amplifier output to provide lower impedance at that critical reference plane for power capability advantage while maintaining the individual ˜50 Ohm path conditions for the filtering.

FIG. 8 depicts an example wireless device 800 having one or more advantageous features described herein. In the context of a module having one or more features as described herein, such a module can be generally depicted by a dashed box 700, and can be implemented as, for example, a front-end module (FEM).

Referring to FIG. 8, power amplifiers (PAs) 820 can receive their respective RF signals from a transceiver 810 that can be configured and operated in known manners to generate RF signals to be amplified and transmitted, and to process received signals. Similarly, low-noise amplifiers (LNAs) 826 can receive their respective signals for delivery to the transceiver 810. The transceiver 810 is shown to interact with a baseband sub-system 808 that is configured to provide conversion between data and/or voice signals suitable for a user and RF signals suitable for the transceiver 810. The transceiver 810 can also be in communication with a power management component 806 that is configured to manage power for the operation of the wireless device 800. Such power management can also control operations of the baseband sub-system 808 and the module 700.

The baseband sub-system 808 is shown to be connected to a user interface 802 to facilitate various input and output of voice and/or data provided to and received from the user. The baseband sub-system 808 can also be connected to a memory 804 that is configured to store data and/or instructions to facilitate the operation of the wireless device, and/or to provide storage of information for the user.

In the example wireless device 800, outputs of the PAs 820 are shown to be matched (via respective match circuits 822) and routed to a duplexer 707 for routing to a particular antenna 816a, 816b. The duplexer 707 can be configured as any of the duplexers described herein. In some embodiments, the duplexer 707 can include an antenna switch module for routing to a targeted antenna. Additionally or alternatively, an antenna switch module 764 can be implemented between the duplexer 707 and the antennas 816a, 816b for routing to a targeted antenna. Thereby, the antenna switch module 764 can be configured as any of the antenna switch modules described herein. Received signals are routed to low-noise amplifiers (LNAs) 826 through a match circuit 824. The duplexer 707 includes a transmit port 701 for receiving a transmit RF signal and a receive port 702 for providing a receive RF signal. The duplexer 707 also includes a plurality of antenna ports 730 respectively coupled to the plurality of antennas 816a, 816b. The duplexer 707 is configured to route the transmit RF signal from the transmit port 701 to a first antenna port of the plurality of antenna ports 730 selected based on an antenna select signal. The duplexer 707 is also configured to route the receive RF signal to the receive port 702 from a second antenna port of the plurality of antenna ports 730 selected based on the antenna select signal. The module also includes a controller 840 configured to provide the antenna select signal to the duplexer 707, as described in greater detail herein.

A number of other wireless device configurations can utilize one or more features described herein. For example, a wireless device does not need to be a multi-band device. In another example, a wireless device can include additional antennas such as diversity antennae, and additional connectivity features such as Wi-Fi, Bluetooth, and GPS.

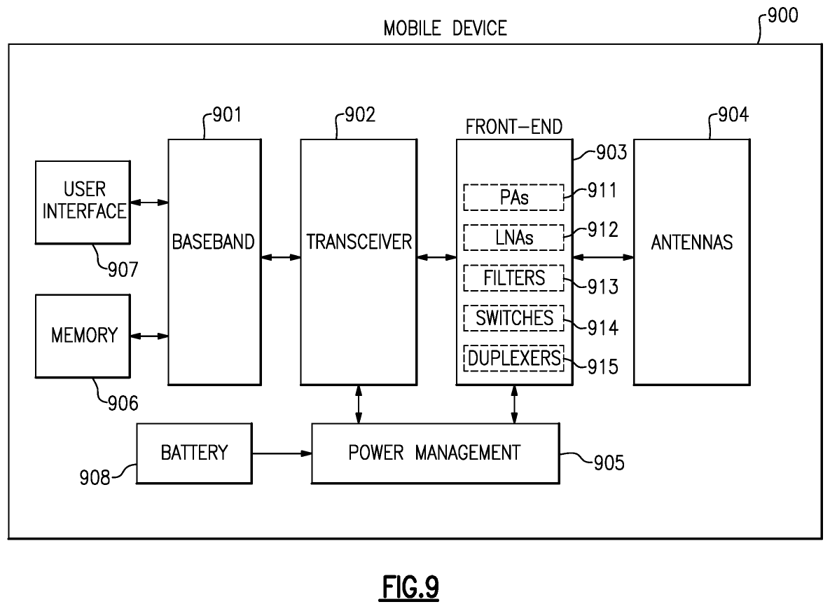

FIG. 9 is a schematic diagram of one example of a mobile device 900. The mobile device 900 includes a baseband system 901, a transceiver 902, a front-end system 903, antennas 904, a power management system 905, a memory 906, a user interface 907, and a battery 908.

The mobile device 900 can be used communicate using a wide variety of communications technologies, including, but not limited to, 2G, 3G, 4G (including LTE, LTE-Advanced, and LTE-Advanced Pro), 5G NR, WLAN (for instance, Wi-Fi), WPAN (for instance, Bluetooth and ZigBee), WMAN (for instance, WiMax), and/or GPS technologies.

The transceiver 902 generates RF signals for transmission and processes incoming RF signals received from the antennas 904.

The front-end system 903 aids is conditioning signals transmitted to and/or received from the antennas 904. In the illustrated embodiment, the front-end system 903 includes power amplifiers (PAs) 911, low noise amplifiers (LNAs) 912, filters 913, switches 914, and duplexers 915. However, other implementations are possible.

For example, the front-end system 903 can provide a number of functionalities, including, but not limited to, amplifying signals for transmission, amplifying received signals, filtering signals, switching between different bands, switching between different power modes, switching between transmission and receiving modes, duplexing of signals, multiplexing of signals (for instance, diplexing or triplexing), or some combination thereof.

In certain implementations, the mobile device 900 supports carrier aggregation, thereby providing flexibility to increase peak data rates. Carrier aggregation can be used for both Frequency Division Duplexing (FDD) and Time Division Duplexing (TDD), and may be used to aggregate a plurality of carriers or channels. Carrier aggregation includes contiguous aggregation, in which contiguous carriers within the same operating frequency band are aggregated. Carrier aggregation can also be non-contiguous, and can include carriers separated in frequency within a common band or in different bands.

The antennas 904 can include antennas used for a wide variety of types of communications. For example, the antennas 904 can include antennas for transmitting and/or receiving signals associated with a wide variety of frequencies and communications standards.

In certain implementations, the antennas 904 support MIMO communications and/or switched diversity communications. For example, MIMO communications use multiple antennas for communicating multiple data streams over a single radio frequency channel. MIMO communications benefit from higher signal to noise ratio, improved coding, and/or reduced signal interference due to spatial multiplexing differences of the radio environment. Switched diversity refers to communications in which a particular antenna is selected for operation at a particular time. For example, a switch can be used to select a particular antenna from a group of antennas based on a variety of factors, such as an observed bit error rate and/or a signal strength indicator.

The mobile device 900 can operate with beamforming in certain implementations. For example, the front-end system 903 can include phase shifters having variable phase controlled by the transceiver 902. Additionally, the phase shifters are controlled to provide beam formation and directivity for transmission and/or reception of signals using the antennas 904. For example, in the context of signal transmission, the phases of the transmit signals provided to the antennas 904 are controlled such that radiated signals from the antennas 904 combine using constructive and destructive interference to generate an aggregate transmit signal exhibiting beam-like qualities with more signal strength propagating in a given direction. In the context of signal reception, the phases are controlled such that more signal energy is received when the signal is arriving to the antennas 904 from a particular direction. In certain implementations, the antennas 904 include one or more arrays of antenna elements to enhance beamforming.

The baseband system 901 is coupled to the user interface 907 to facilitate processing of various user input and output (I/O), such as voice and data. The baseband system 901 provides the transceiver 902 with digital representations of transmit signals, which the transceiver 902 processes to generate RF signals for transmission. The baseband system 901 also processes digital representations of received signals provided by the transceiver 902. As shown in FIG. 9, the baseband system 901 is coupled to the memory 906 of facilitate operation of the mobile device 900.

The memory 906 can be used for a wide variety of purposes, such as storing data and/or instructions to facilitate the operation of the mobile device 900 and/or to provide storage of user information.

The power management system 905 provides a number of power management functions of the mobile device 900. In certain implementations, the power management system 905 includes a PA supply control circuit that controls the supply voltages of the power amplifiers 911. For example, the power management system 905 can be configured to change the supply voltage(s) provided to one or more of the power amplifiers 911 to improve efficiency, such as power added efficiency (PAE).

As shown in FIG. 9, the power management system 905 receives a battery voltage from the battery 908. The battery 908 can be any suitable battery for use in the mobile device 900, including, for example, a lithium-ion battery.

The front-end system 903 of FIG. 9 can be implemented in accordance with one or more features of the present disclosure. Although the mobile device 900 illustrates one example of a RF communication device that can include a RFFE system implemented in accordance with the present disclosure, the teachings herein are applicable to a wide variety of RF electronics.

### Applications

Some of the embodiments described above have provided examples in connection with wireless devices or mobile phones. However, the principles and advantages of the embodiments can be used for any other systems or apparatus that have needs for front end modules.

Such front end modules can be implemented in various electronic devices. Examples of the electronic devices can include, but are not limited to, consumer electronic products, parts of the consumer electronic products, electronic test equipment, etc. Examples of the electronic devices can also include, but are not limited to, memory chips, memory modules, circuits of optical networks or other communication networks, and disk driver circuits. The consumer electronic products can include, but are not limited to, a mobile phone, a telephone, a television, a computer monitor, a computer, a hand-held computer, a personal digital assistant (PDA), a microwave, a refrigerator, an automobile, a stereo system, a cassette recorder or player, a DVD player, a CD player, a VCR, an MP3 player, a radio, a camcorder, a camera, a digital camera, a portable memory chip, a washer, a dryer, a washer/dryer, a copier, a facsimile machine, a scanner, a multi-functional peripheral device, a wrist watch, a clock, etc. Further, the electronic devices can include unfinished products.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “can,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While certain embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A radio frequency module comprising:
a power amplifier configured to amplify a transmit radio frequency signal and including an output having a first output impedance; and
an antenna switch module coupled to the output of the power amplifier and configured to connect at least a first antenna having a first input impedance in parallel with at least a second antenna having a second input impedance to the output of the power amplifier so that a parallel connection of the first and second input impedance matches the first output impedance.

2. The radio frequency module of claim 1 wherein the power amplifier is configured to adaptively adjust its power capability when the impedance of a load on the radio frequency module changes.

3. The radio frequency module of claim 1 further comprising a radio frequency filter implemented between the power amplifier and the first antenna.

4. The radio frequency module of claim 3 wherein the performance of the radio frequency filter is invariant with respect to a changing impedance at the output of the radio frequency filter.

5. The radio frequency module of claim 3 further comprising a tunable matching network coupled between the radio frequency filter and the antenna switch module, the tunable matching network configured to adjust the output impedance of the radio frequency filter in a predefined range.

6. The radio frequency module of claim 3 wherein the antenna switch module is implemented between the power amplifier and the radio frequency filter, the radio frequency filter being configured as a duplex filter.

7. The radio frequency module of claim 1 further comprising a phase shifting circuit configured to phase shift the transmit radio frequency signal when the at least one second antenna is concurrently connected in parallel with the at least one first antenna.

8. The radio frequency module of claim 7 wherein the phase shifting circuit is implemented in the antenna switch module and configured as an adjustable phase shifting network.

9. The radio frequency module of claim 7 wherein the phase shifting circuit is implemented between the antenna switch module and each of the at least one first and the at least one second antenna, the phase shifting circuit being configured as a low-loss phase shifting network.

10. The radio frequency module of claim 1 further comprising a low noise amplifier coupled to the antenna switch module and configured to receive a receive radio frequency signal.

11. The radio frequency module of claim 1 wherein the radio frequency module is configured as a front end module.

12. A wireless communication device comprising:
at least one first antenna configured to transmit a first transmit radio frequency signal to a base station via a first uplink and to receive a first receive radio frequency signal from the base station via a first downlink;
at least one second antenna configured to transmit a second transmit radio frequency signal to a base station via a second uplink and to receive a second receive radio frequency signal from the base station via a second downlink; and
a radio frequency module coupled to the at least one first antenna and the at least one second antenna, the radio frequency module including a power amplifier configured to amplify the first and second transmit radio frequency signal and including an output having a first output impedance, and an antenna switch module coupled to the output of the power amplifier and configured to connect at least the first antenna having a first input impedance in parallel with the at least a second antenna having a second input impedance to the output of the power amplifier so that the parallel connection of the first and second input impedance matches the first output impedance.

13. The wireless communication device of claim 12 wherein the power amplifier is configured to adaptively adjust its power capability when the impedance of a load on the radio frequency module changes.

14. The wireless communication device of claim 12 wherein the radio frequency module further includes a radio frequency filter implemented between the power amplifier and the first antenna.

15. The wireless communication device of claim 14 wherein the performance of the radio frequency filter is invariant with respect to a changing impedance at the output of the radio frequency filter.

16. The wireless communication device of claim 14 wherein the radio frequency module further includes a tunable matching network coupled between the radio frequency filter and the antenna switch module, the tunable matching network configured to adjust the output impedance of the radio frequency filter in a predefined range.

17. The wireless communication device of claim 14 wherein the antenna switch module is implemented between the power amplifier and the radio frequency filter, the radio frequency filter being configured as a duplex filter.

18. The wireless communication device of claim 12 wherein the radio frequency module further includes a phase shifting circuit configured to phase shift the transmit radio frequency signal when the at least one second antenna is concurrently connected in parallel with the at least one first antenna.

19. The wireless communication device of claim 18 wherein the phase shifting circuit is implemented in the antenna switch module and configured as an adjustable phase shifting network.

20. The wireless communication device of claim 18 wherein the phase shifting circuit is implemented between the antenna switch module and each of the at least one first antenna and the at least one second antenna, the phase shifting circuit being configured as a low-loss phase shifting network.
